(19) United States
(12) Patent Application Publication
(10) Pub. No.: US 2024/0198491 A1
(43) Pub. Date: Jun. 20, 2024

(54) SELF-LOCKING AND ADJUSTABLE DUAL RATCHET CLAMPING APPARATUS

(71) Applicant: Geng Yan, Calgary (CA)

(72) Inventor: Geng Yan, Calgary (CA)

(21) Appl. No.: 18/502,010

(22) Filed: Nov. 4, 2023

Related U.S. Application Data
(60) Provisional application No. 63/433,170, filed on Dec. 16, 2022.

(51) Int. Cl. B25B 5/08; B25B 5/16

(52) U.S. Cl. CPC B25B 5/085; B25B 5/163; B25B 5/166

(57) ABSTRACT

The self-locking and adjustable dual ratchet clamping apparatus comprises a frame which is either a single rail or a dual rail structure having an integral ratchet rack on a side, a fixed jaw at one end of the frame, a movable jaw mounted on the frame and moves along the rail structure relative to the fixed jaw, a first ratchet system including a rotatable ratchet trigger pivotally connected to the movable jaw and is engaged with a locking pawl supported by the movable jaw to form a directional self-locking mechanism, a second ratchet system including a driving pawl engaged with the ratchet rack to form another directional self-locking mechanism, and a cascading mechanism connecting the first and second ratchet systems whereby the rotation of the rotatable ratchet trigger drives the movement of the driving pawl thereby translated into the movable jaw movement relative to the fixed jaw.

### REFERENCE TO RELATED APPLICATIONS

This application claims the benefit of U.S. Provisional Application No. 63/433,170, filed on Dec. 16, 2022.

### FIELD OF THE INVENTION

The present invention relates to a self-locking and adjustable dual ratchet clamping apparatus that utilizes a cascading dual ratchet system to provide adjustable clamping gap, clamping force and self-locking function for applications such as plumbing wrench, wood clamp, jar opener and many others. The present invention offers easy and convenient operation on a wide range of the underlining workpieces the apparatus is operated on, such as plumbing connectors, lumbers, jar lids, etc., and also provides convenient clamping force adjustment and self-locking function.

### BACKGROUND OF THE INVENTION

In many clamping applications such as plumbing wrench, mechanical wrench, wood clamp, jar opener and many others, the apparatus is required to have a variable clamping gap that can be quickly adjusted to adapt to a wide range of sizes of the underlining workpieces it is operated on, such as the plumbing connector diameters, bolt/nut diameters, lumber widths, jar lid diameters, etc. In many cases the apparatus is also required to provide clamping force on the underlining workpiece, so that the underlining workpiece can be firmly locked in a position, such as in the wood clamp application; or the apparatus can be firmly clamped onto the workpiece so that it will not easily detach from the workpiece and torque can be applied with ease of control, such as in the plumbing wrench, jar opener, and mechanical wrench applications. This creates the needs for a clamping apparatus that can provide a quick clamping gap and force adjustment, as well as a self-locking mechanism so that a user does not have to keep applying clamping force or maintaining the gap when in operation. The self-locking mechanism is especially beneficial to a wide range of users who either have weak hand grip due to old age or illnesses such as arthritis, or do not have the dexterity to coordinate applying proper clamping force while operating the apparatus.

While there are many devices exist in prior art and commercially available tools for these applications, there is no such a force-adjustable, self-locking and cascading dual ratchet mechanism implemented to achieve aforementioned convenient operations.

Therefore, there is a strong need for this invention to provide quick adjustable clamping gap and clamping force, and a self-locking mechanism to improve existing tools and provide easier and more convenient operations.

### SUMMARY OF THE INVENTION

The primary object of the present invention is to provide a cascading dual ratchet mechanism that can offer quick clamping gap and force adjustment and self-locking function via the cascading pawl and ratchet engagements.

The second object is to provide a single rail system to implement said cascading dual ratchet mechanism so that a pair of opposing clamping ends have a variable gap along the single rail.

The other object is to provide a dual rail system to implement said cascading dual ratchet mechanism so that a pair of opposing clamping ends have a variable gap along the dual rail.

To the accomplishment of the above and related objects, this invention may be embodied in the preferred embodiments illustrated in the accompanying drawings. It should be noted however, that the drawings are illustrative only, and that various modifications can be made to achieve the same objectives.

### BRIEF DESCRIPTION OF DRAWINGS

Various other objects, features and advantages of the present invention will become fully appreciated and better understood when considered in conjunction with the accompanying drawings, wherein for the preferred embodiments:

FIG. 1 is a perspective view of a preferred embodiment of a single rail self-locking and adjustable dual ratchet clamping apparatus (referred to as single rail clamping apparatus hereon) in the application as a plumbing wrench.

FIG. 2 is an exploded view of the plumbing wrench of FIG. 1.

FIG. 3 is combination of orthographic and sectional views of the plumbing wrench of FIG. 1.

FIG. 4 is a combination of orthographic, sectional and perspective views of a movable jaw that may be used on the plumbing wrench of FIG. 1.

FIG. 5 is perspective view of a locking pawl that may be used on the plumbing wrench of FIG. 1.

FIG. 6 is a perspective view of a linkage that may be used on the plumbing wrench of FIG. 1.

FIG. 7 is a perspective view of a driving pawl that may be used on the plumbing wrench of FIG. 1.

FIG. 8 is a perspective view of a plug that may be used on the plumbing wrench of FIG. 1.

FIG. 9 is a combination of orthographic, sectional and perspective views of a ratchet trigger that may be used on the plumbing wrench of FIG. 1.

FIG. 10 is a projection view that illustrates how the cascading mechanism of the plumbing wrench of FIG. 1 translates rotation into linear movement.

FIG. 11 is a perspective view that illustrates how the plumbing wrench of FIG. 1 can be used to operate on a commercial sink connector.

FIG. 12 is a perspective view that illustrates how the plumbing wrench of FIG. 1 can be used to operate on a commercial PVC/ABS pipe connector.

FIG. 13 is a perspective view that illustrates how the plumbing wrench of FIG. 1 can be used to operate on a commercial octagon sink connector.

FIG. 14 is an exploded view of another preferred embodiment of the single rail clamping apparatus in the application as a plumbing wrench.

FIG. 15 is a perspective view of a frame that may be used on the plumbing wrench of FIG. 14.

FIG. 16 is a perspective view of a movable jaw that may be used on the plumbing wrench of FIG. 14.

FIG. 17 is a perspective view that illustrates how the plumbing wrench of FIG. 14 can be used to operate on a commercial waterline connector.

FIG. 18 is an exploded view of another preferred embodiment of the single rail clamping apparatus in the application as a plumbing wrench.

FIG. 19 is a perspective view of an integrated driving pawl linkage that may be used on the plumbing wrench of FIG. 18.

FIG. 20 is an exploded view of another preferred embodiment of the single rail clamping apparatus in the application as a plumbing wrench.

FIG. 21 is a perspective view of a driving pawl that may be used on the plumbing wrench of FIG. 20.

FIG. 22 is a perspective view of a pawl bracket that may be used on the plumbing wrench of FIG. 20.

FIG. 23 is a perspective view of a slider head that may be used on the plumbing wrench of FIG. 20.

FIG. 24 is a combination of orthographic and sectional views of the plumbing wrench of FIG. 20.

FIG. 25 is a perspective view of a preferred embodiment of a single rail clamping apparatus in the application as a wood clamp.

FIG. 26 is an exploded view of the wood clamp of FIG. 25.

FIG. 27 is a combination of orthographic and sectional views of the wood clamp of FIG. 25.

FIG. 28 is a perspective view of a frame that may be used on the wood clamp of FIG. 25.

FIG. 29 is a perspective view of a fixed jaw that may be used on the wood clamp of FIG. 25.

FIG. 30 is a perspective view of a movable jaw that may be used on the wood clamp of FIG. 25.

FIG. 31 is a perspective view that illustrates how the wood clamp of FIG. 25 can be used to lock two pieces of wood boards in relative fixed position.

FIG. 32 is a perspective view that illustrates how the wood clamp of FIG. 25 can be used to lock and maintain the relative spacing distance between two pieces of lumber.

FIG. 33 is a perspective view of a preferred embodiment of a dual rail self-locking and adjustable dual ratchet clamping apparatus (referred to as a dual rail clamping apparatus hereon) in the application as a jar opener.

FIG. 34 is a different angle perspective view of the jar opener of FIG. 33.

FIG. 35 is an exploded view of the jar opener of FIG. 33.

FIG. 36 is a combination of orthographic and sectional views of the jar opener of FIG. 33.

FIG. 37 is a perspective view of a fixed jaw that may be used on the jar opener of FIG. 33.

FIG. 38 is a perspective view of a movable jaw that may be used on the jar opener of FIG. 33.

FIG. 39 is a perspective view of a ratchet trigger that may be used on the jar opener of FIG. 33.

FIG. 40 is a perspective view of an integrated driving pawl linkage that may be used on the jar opener of FIG. 33.

FIG. 41 is a perspective view of a locking pawl that may be used on the jar opener of FIG. 33.

FIG. 42 is a perspective view of an elastic member that may be used on the jar opener of FIG. 33.

FIG. 43 is a perspective view that illustrates how the jar opener of FIG. 33 can be used to operate on a jar lid.

### DETAILED DESCRIPTION OF THE INVENTION

Described below are the preferred embodiments of the present invention, which illustrate ways in which the invention may be implemented. Although the embodiments shown are described in the context of plumbing wrench, wood clamp and jar opener, the invention can also be used for suitable applications such as mechanical wrench and many others that require adjustable clamping gap and clamping force. In the descriptions that follow, the preferred embodiments are disclosed in detail to illustrate the principles of the invention. Therefore, it should be noted that the preferred embodiments are merely respective forms of the many potential embodiments in many applications, and the structural and functional details described herein are not intended to be limiting of the invention, but merely serve as the exemplary representations and the principles of the present invention.

In the disclosure the same reference characters represent the same elements in all figures. The references of “up”, “down”, “upper”, “lower”, “top”, “bottom”, “vertical”, “horizontal”, “front”, “rear” and so on are based on the positions shown on the views. Terms like “first”, “second”, “third”, “forth”, “last”, “one”, “another”, “on one end”, “on the other end” and so on are used to arbitrarily distinguish the elements in relation to the position and/or the sequence of a description or illustration. On the figures with a combination of orthographic, sectional and perspective views, the reference characters may not be indicated to avoid reducing legibility of the drawing details, however the components will become obvious on the other views.

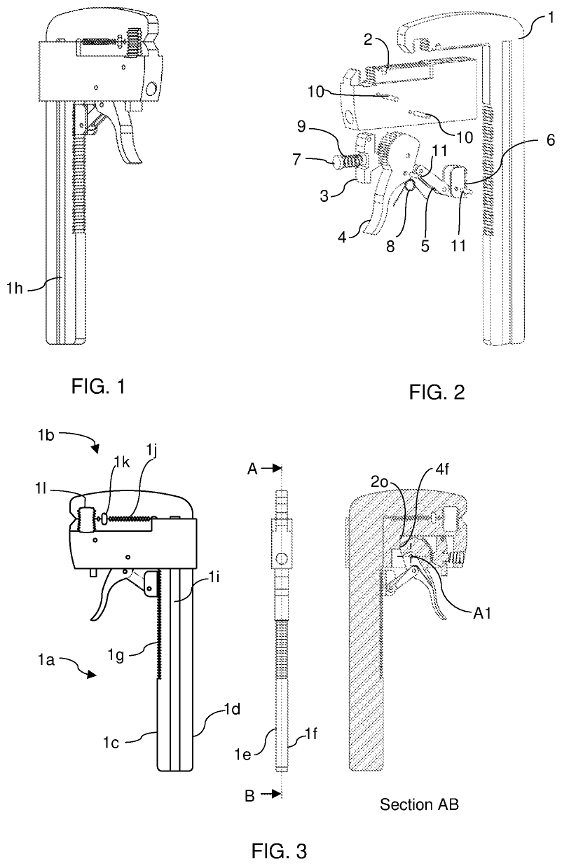

FIG. 1 illustrates a single rail clamping apparatus in its uppermost position in a preferred embodiment as a plumbing wrench.

FIG. 2 and FIG. 3 further show how the plumbing wrench of FIG. 1 is constructed. The plumbing wrench may comprise a frame 1, a movable jaw 2, a locking pawl 3, a ratchet trigger 4, a linkage 5, a driving pawl 6, a plug 7, a plurality of elastic members 8 and 9, and a plurality of pins 10 and 11.

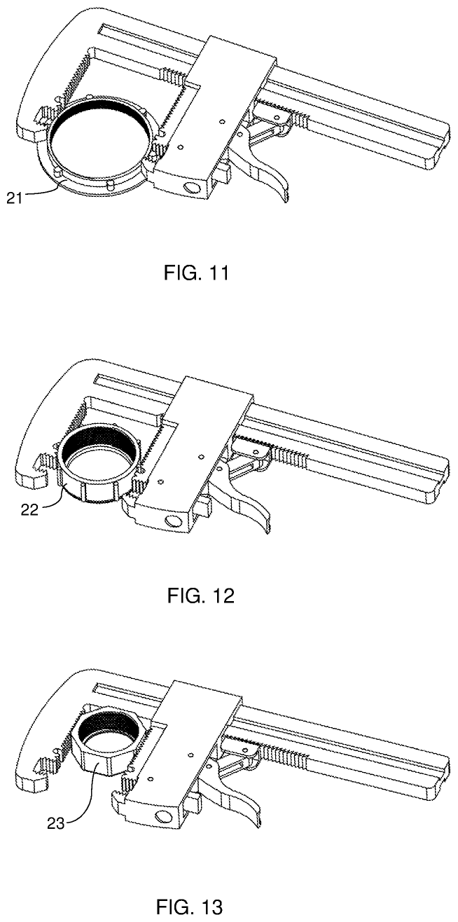

The frame 1 (FIG. 1, 2, 3) having a similar to a J hook body may comprise a longitudinal rail section 1a connected by a J hook fixed jaw section 1b protruding transversely from the top end of the rail section 1a. Two generally parallel longitudinal edges 1c and 1d define the width of the rail section 1a, and two generally parallel lateral edges 1e and 1f define the thickness of the frame 1. The rail section 1a may further comprise an integral longitudinal ratchet rack 1g disposed in the middle of the inner longitudinal edge 1c, and a pair of guiding slots 1h and 1i disposed on two lateral faces respectively between and generally parallel to the longitudinal edges 1c and 1d. The lateral edges 1e and 1f, the longitudinal edges 1c and 1d, and the surfaces of the slots 1h and 1i together form the supporting surfaces for the movable jaw. The fixed jaw section 1b may comprise an inward-facing gripping face 1j adjacent to the inner longitudinal edge 1c having a plurality of indentations 1k and 1l to adapt to various connector shapes as shown on FIGS. 11, 12 and 13. The rail section 1a functions as a rail for the movable jaw 2, a ratchet rack, as well as a handle. The pair of slots 1h and 1i function as the sliding guide and support for the movable jaw 2.

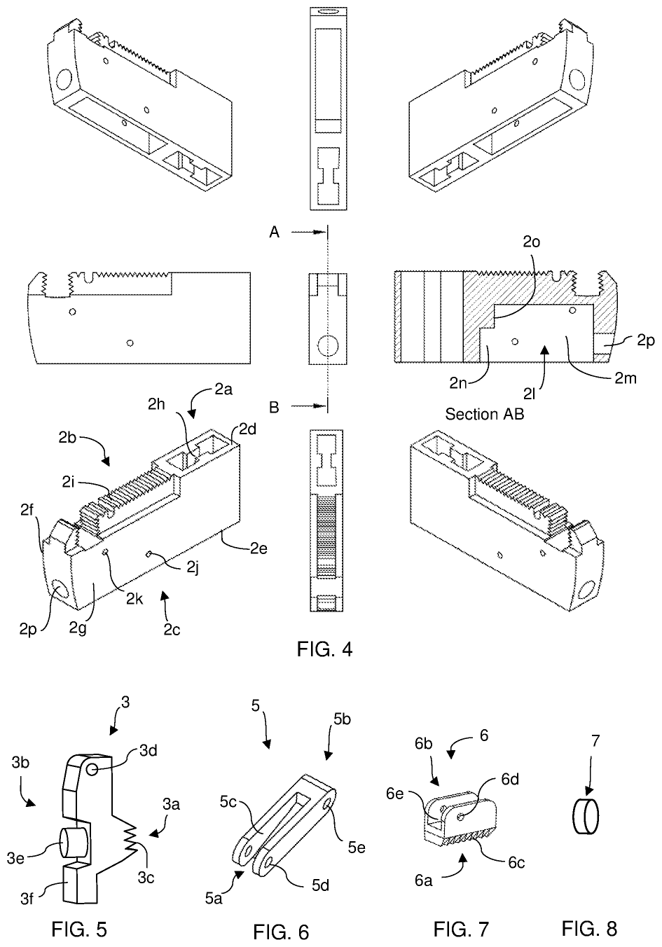

The movable jaw 2 (FIG. 2, FIG. 3, FIG. 4) having an elongated body may comprise a tube section 2a on one end, a frontal movable jaw section 2b back-to-back on top of a ratchet housing section 2c on the other end. Two generally parallel edges 2d and 2e define the height of the body, and two generally parallel lateral edges 2f and 2g define the thickness of the body. The tube section 2a may comprise a cutout 2h between two edges 2d and 2e sized and shaped to couple with and circumscribe the surfaces of the rail section 1a, such that the movable jaw 2 is carried by the rail section 1a and is freely slidable along the rail section 1a towards or away from the fixed jaw section 1b.

The movable jaw section 2b (FIG. 4) may comprises a frontal gripping face 2i sized and shaped to match the opposing gripping face 1j of the fixed jaw section 1b, such that they pair up to form a pair of jaws to clamp on a workpiece. The profiles of the gripping faces 1j and 2i are designed to adapt to and maximize the grip on different type of commercial plumbing connectors. The movable jaw section 2b may have a reduced lateral thickness offset from both lateral edges 2f and 2g to match the thickness of the fixed jaw section 1b, such that their lateral faces are generally flushed and do not interfere with the flat base of a workpiece clamped in between, such as a flange type plumbing connector as shown on FIG. 10.

The ratchet housing section 2c (FIG. 4) may comprise a stepped recess 21 from the edge 2e. The stepped recess 21 may consist of a shallow recess portion 2n adjacent to the tube section 2a to form a rotation limit face 20, a deep recess portion 2m to house the locking pawl 3 and the ratchet trigger 4, a first pair of hinge seats 2j and a second pair of hinge seats 2k on the lateral walls of the deep recess portion 2m to pivotally connect with the ratchet trigger 4 and the locking pawl 3 respectively via the pins 10. The ratchet housing section 2c may further comprise a horizontal circular cutout 2p, forming a tunnel from the deep recess 2m to the end of the ratchet housing section 2c to receive an elastic member 9 and the plug 7. The plug 7 is affixed to and blocks the outward opening of the cutout 2p and acts as a support for one end of the elastic member 9. The plug 7 may not be needed if the circular cutout 2p is formed without the outward opening at the end of the ratchet housing section 2c, such that one end of the elastic member 9 is directly supported by the ratchet housing section 2c.

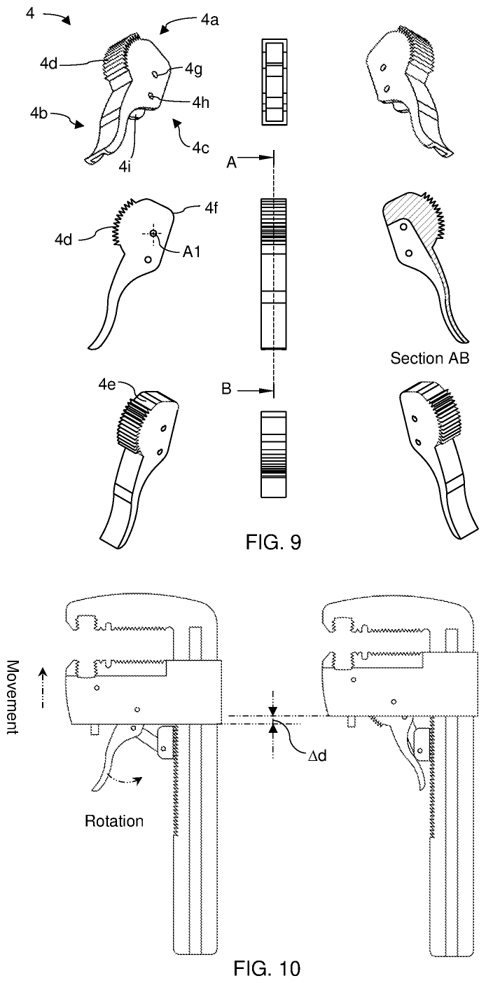

The ratchet trigger 4 (FIG. 2, FIG. 3, FIG. 9) having a similar to a trigger shape longitudinal body may comprise a transversely protruding ratchet head section 4a, a curvy longitudinal trigger arm section 4b, a pivot section 4c and a curvy notched slot 4i. The ratchet head section 4a may have a similar to a fan disc shape body comprising a lateral integral arc ratchet face 4d coaxial to the axis A1 to engage with the locking pawl 3 to form a first ratchet system, a first pair of hinge seats 4g centered on the axis A1 to pivotally connect with the first pair of hinge seats 2j of the movable jaw 2 via a pin 10 and form a first pivot, and a lateral curvature face 4e starting from the end of the ratchet face 4d to the pivot section 4c to form a rotation limit peak 4f such that an initial position of the ratchet trigger is formed when the rotation limit peak 4f is against the rotation limit face 20 (FIG. 3). The trigger arm section 4b may project from the lower end of the ratchet head 4a, forming a curvy lever. The notched slot 4i may run across the underside of the trigger arm section 4b and extend to the lower portion of the ratchet head 4a; The pivot section 4c may comprise a second pair of hinge seats 4h adjacent to the lower portion of the rachet head 4a, whereby to receive and pivotally connect with the linkage 5 and an elastic member 8 via the second pair of hinge seats 4h and a pin 11 to form a second pivot, thereof the second pivot is rotatable about the first pivot.

The locking pawl 3 (FIG. 5) may comprise a lateral pawl head section 3a and a support section 3b back-to-back oriented thereof sized to be movably received into the ratchet housing section 2c, and a release section 3f. The pawl head section 3a may comprise a protruding pawl head having an integral pawl face 3c sized and shaped to engage with the ratchet face 4d of the ratchet trigger 4 (FIG. 3) to form the first ratchet system. The support section 3b may comprise a top bore hole 3d to pivotally connect with the second pair of hinge seats 2k of the movable jaw 2 via another pin 10 such that the locking pawl 3 is rotatably supported by the movable jaw, a protruding cylinder head 3e sized and shaped to be received into another end of the elastic member 9. The elastic member 9 provides a first elastic force to urge the engagement of the first ratchet system. The underbody release section 3f may be exposed to the outside of the movable jaw 2 for disengagement operation.

The driving pawl 6 (FIG. 7) may have a body comprising a pawl head section 6a and a pivot section 6b back-to-back oriented. The pawl section 6a may comprise a plurality of pawl teeth forming an integral pawl face 6c sized and shaped to engage with the ratchet rack 1g of the frame 1 and form a second ratchet system. The pivot section 6b may comprise a notched slot 6e and a pair of hinge seats 6d disposed closer to the lower end of the body when assembled. The arrangement of the pair of hinge seats 6d can be, but need not be, used to increase leverage to counter the rotating force created by the friction between the top pawl tooth and the ratchet rack 1g when the movable jaw 2 is slid forward.

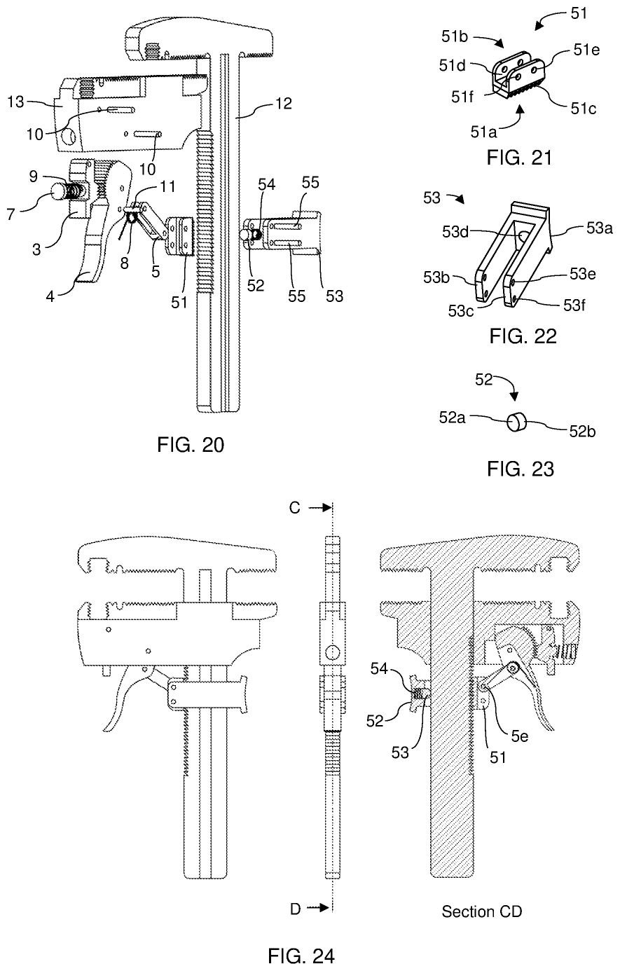

The linkage 5 (FIG. 6) may have a longitudinal body comprising a first pivoting end 5a having a notched slot 5c between a pair of hinge seats 5d to receive the elastic member 8 on one end, and a second pivoting end 5b having a bore hole 5e on the other end. The linkage 5 is pivotally connected to the second pair of hinge seats 4h of the ratchet trigger 4 and the elastic member 8 via the pair of hinge seats 5d and the pin 11 on the first pivoting end 5a to form the second pivot, and pivotally connected to the driving pawl 6 via the bore hole 5e, the pair of hinge seats 6d and another pin 11 on the second pivoting end 5b. Linkage 5 functions as a cascading mechanism to cascade the first ratchet system movement to the second rachet system movement thereby translating the rotation of the ratchet trigger 4 into the linear movement of the driving pawl 6. The elastic member 8 supported between the ratchet trigger 4 and the linkage 5 in effect provides a second elastic force between the frame 1 and the ratchet trigger 4 to urge the trigger arm section 4b to rotate away from the rail section 1a of the frame 1, and a third elastic force between the driving pawl 6 and the frame 1 to urge the engagement of the second ratchet system. Such effect is made possible because after being assembled the frame 1 supports all other components directly or indirectly via the assembly relationship. Therefore, the same results may be achieved by separately providing the second elastic force from one of the pluralities of elastic members supported directly or indirectly between the ratchet trigger 4 and the frame 1, and the third elastic force from another one of the plurality of elastic members supported directly or indirectly between the driving pawl 6 and the frame 1, which will be further illustrated on FIG. 20 to FIG. 24.

The first ratchet system is configured in such a way that when the trigger arm section 4b is rotated closer to the rail section 1a from the initial position, the ratchet face 4d pushes away the pawl face 3c to disengage the first ratchet system and allow the trigger arm section 4b to continue to be rotated forward closer to the rail section 1a until stopped directly or indirectly by the frame 1, forming a final position; and when the trigger arm section 4b stops being rotated forward, the first elastic force urges the engagement of the first ratchet system and locks the ratchet trigger 4 in a fixed position, preventing the ratchet arm section 4b from being rotated backward away from the rail section 1a by the second elastic force, thereby forming a directional self-locking mechanism. When an overcoming force is applied to the release section 3f to counter the first elastic force, the pawl face 3c is moved apart from the ratchet face 4d to disengage the first ratchet system, and the second elastic force urges the ratchet arm section 4b to rotate away from the rail section 1a until reaching the initial position, thereby resetting the ratchet trigger 4.

The second ratchet system is configured in such a way that when the movable jaw 2 is slid forward closer to the fix jaw section 1b, the ratchet rack 1g pushes away the pawl face 6c to disengage the second ratchet system and allow the movable jaw 2 to continue to be slid forward until stopped by a work piece or the fixed jaw section 1b; and when the movable jaw 2 stops being slid forward, the third elastic force urges the engagement of the second ratchet system, thereby preventing the movable jaw 2 from being slid backward and forming another directional self-locking mechanism.

FIG. 10 further shows how the cascading mechanism translate the rotation of the ratchet trigger 4 into the linear movement of the movable jaw 2. The first ratchet system may be disengaged to allow the ratchet trigger 4 to reset to the initial position and trigger arm section 4b to reach its maximum distance away from the rail section 1a while the second ratchet system is engaged. The trigger arm section 4b may then be rotated anti-clockwise (as indicated by the “Rotation” on FIG. 10) closer to the ratchet rack 1g to actuate the cascading mechanism until stopped indirectly by the frame 1 at the final position, whereby the driving pawl 6 is driven by the linkage 5 backward away from the movable jaw 2 via the rotation of the second pivot about the first pivot. When the second ratchet system is engaged, the movable jaw 2 in turn is driven forward (as indicated by the “Movement” on FIG. 10) closer to the fixed jaw section 1b by a distance of Δh, which defines a maximum incremental gap reduction range.

FIG. 11-FIG. 13 further show how the plumbing wrench can be used to operate on a flange type sink connector 21, a PVC/ABS connector 22 and an octagon sink connector 23.

A user may use the release section 3f to actuate the disengagement of the first ratchet system, thereby allowing the ratchet trigger 4 to reset to the initial position. The user may then pull the driving pawl 6 away from the ratchet rack 1g, and slide down the movable jaw 2 to create sufficient gap between the pair of jaws. The user may then place a workpiece between the pair of jaws, and slide the movable jaw 2 forward to the fixed jaw section 1b until stopped by the workpiece; the third elastic force then urges the engagement of the second ratchet system and the driving pawl 6 is locked in a highest possible fixed position, while there may still be slack between the workpiece and the pair of jaws. The user may proceed to pull the trigger arm section 4b closer to the ratchet rack 1g to actuate the cascading mechanism, whereby the movable jaw 2 is driven incrementally forward until the workpiece is in firm contact with the pair of jaws. From this point on any gap reduction effort translates into slight distortions of the workpiece and all components involved, which in turn provide an increasing clamping force on the workpiece. When the trigger arm section 4b is released, the locking pawl 3 locks the ratchet trigger 4 in a fixed position such that the majority of the clamping force is retained via elastic deformation. The user may then turn the workpiece by the handle to tighten or loosen the workpiece, without having to keep a constant pressure on the trigger arm 4b.

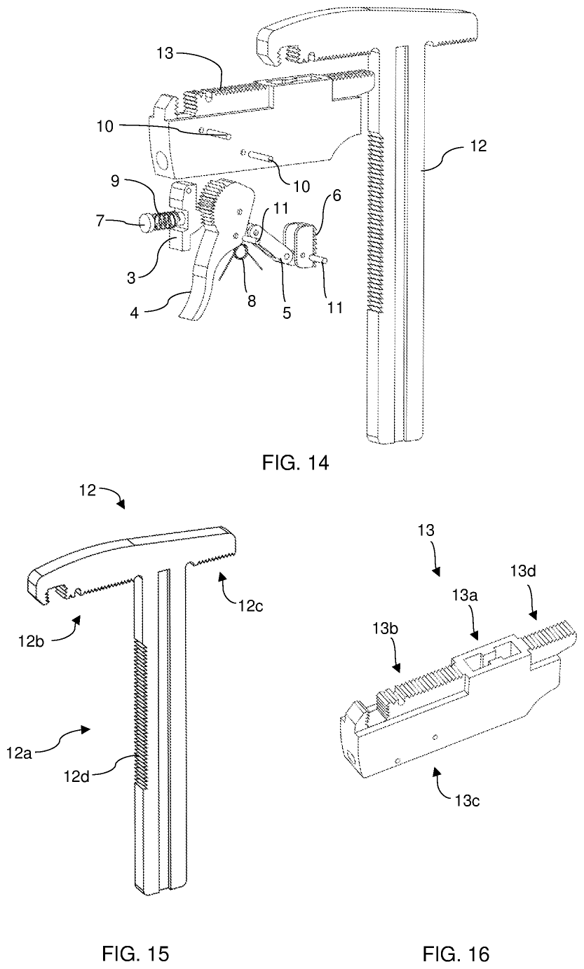

FIG. 14 to FIG. 16 illustrate a single rail clamping apparatus in another preferred embodiment as a plumbing wrench. In accordance to this embodiment the “J” shape frame 1 of FIG. 2 may be replaced by a “T” shape frame 12, and the movable jaw 2 of FIG. 2 may be replaced by a movable jaw 13; the other components may remain the same as the plumbing wrench of FIG. 2.

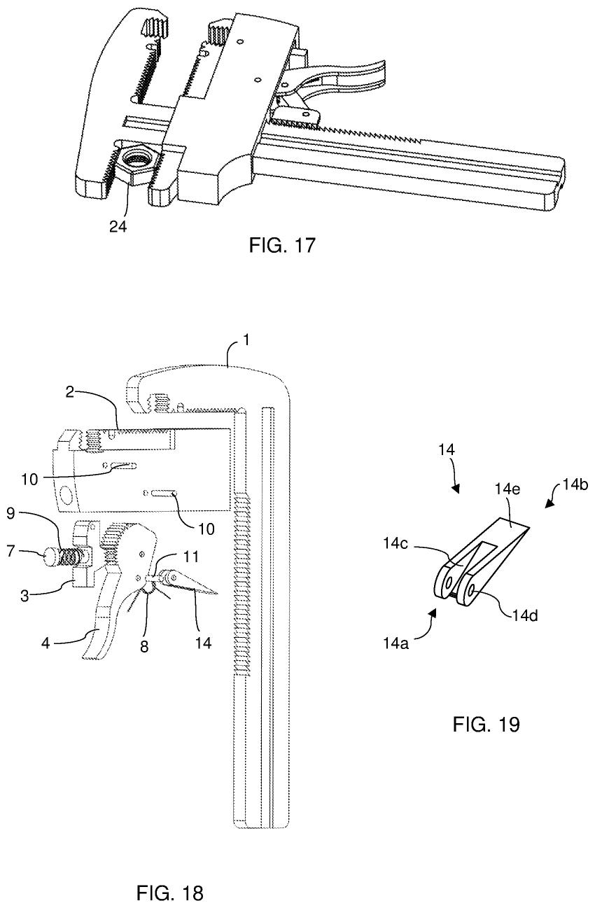

The frame 12 (FIG. 15) may comprise a longitudinal rail section 12a having a longitudinal ratchet rack 12d disposed on a longitudinal edge of the rail section 12a and is integral to the longitudinal edge, a first fixed jaw section 12b having a first griping face and a second fixed jaw section 12c having a second griping face disposed on both sides of the end of the rail section 12a to form two transversely protruding fixed jaws. The movable jaw 13 may comprise a tube section 13a having identical structure as the tube section 2a of the movable jaw 2, a ratchet housing section 13c having identical structure as the ratchet housing section 2c, a first movable jaw section 13b having a first griping face and a second movable jaw section 13d having a second griping face disposed on both sides of the tube section 13a. The first and second movable jaw sections 13b and 13d are sized and shaped to pair up with and oppose to the first and second fixed jaw sections 12b and 12c respectively to form a first pair of jaws and a second pair of jaws. The second pair of jaws may have a shorter jaw length to offer increased operational stability on smaller plumbing connectors such as a waterline connector 24 shown on FIG. 17.

FIG. 18 to FIG. 19 illustrate a single rail clamping apparatus in yet another preferred embodiment as a plumbing wrench when the clamping force required is not significant. In accordance to this embodiment the linkage 5 and the driving pawl 6 of FIG. 2 may be replaced by a driving pawl linkage 14, and the other components may remain the same as the plumbing wrench of FIG. 2.

The driving pawl linkage 14 having a longitudinal body may comprise a pivoting end 14a having a slotted cutout 14c between a pair of hinge seats 14d thereof the pair of hinge seats 14d is pivotally connected to the second pair of hinge seats 4h (FIG. 9) and an elastic member 8 via a pin 11 to form a cascading mechanism, and a pawl head end 14b having an integral pawl tooth 14e sized and shaped to engage with the ratchet rack 1g of the frame 1 to form a second ratchet system.

FIG. 20 to FIG. 24 illustrate a single rail clamping apparatus in yet another preferred embodiment as a plumbing wrench. In accordance to this embodiment the driving pawl 6 of the plumbing wrench of FIG. 14 may be replaced by a driving pawl 51; a slider head 52, a bracket 53, an elastic member 54 and a plurality of pins 55 may be employed to enhance the operational stability of the driving pawl 51; and the other components may remain the same as the plumbing wrench of FIG. 14.

The driving pawl 51 (FIG. 21) may comprise a pawl head section 51a identical to the pawl head section 6a to engage with the ratchet rack 12d of the frame 12 (FIG. 15) to form a second ratchet system, and a pivot section 51b similar to the pivot section 6b back-to-back oriented. The pivot section 51b may further comprise a notched slot 51d and two pairs of hinge seats 51e and 51f disposed on both ends of the pivot section 51b. The slider head 52 (FIG. 23) may comprise a semi-spherical head 52a and a cylindrical section 52b. The pawl bracket 53 (FIG. 22) may comprise an outward-facing depressed thumb press section 53a, and a pair of generally parallel forked arms 53b and 53c forked from and bridged by the thumb press section 53a on one end thereby forming an opening on the other end; the pair of forked arms 53b and 53c are spaced to slidably receive the rail section 12a of the frame 12 in the middle section and receive the driving pawl 51 at the end of the opening having the pawl face 51c facing the ratchet rack 12d, and may further comprise two pairs of hinge seats 53e and 53f at the end of the opening spaced to align and stationarily connect with two pairs of hinge seats 51e and 51f respectively via two pins 55; the thumb press section 53a may further comprise an inward-facing recess 53d disposed in the middle between the pair of forked arms 53b and 53c to slidably receive the elastic member 54 and the cylindrical section 52b of the slider head 52, thereby the elastic member 54 is supported between the pawl bracket 53 and the slider head 52, and the head 52a is in turn slidably supported by the frame 12. A user may press down the thumb press section 53a to disengage the second ratchet system and slide down the movable jaw 13.

The embodiment of FIG. 20 is designed to provide an additional elastic force to urge the engagement of the second ratchet system and enhance the operational stability. This embodiment also illustrates that the third elastic force to urge the engagement of the second ratchet system may be provided by an individual elastic member such as the elastic member 54 supported directly or indirectly between the driving pawl 51 and the frame 12. In other embodiments, the pawl bracket 53 may be constructed to have the pair of forked arms 53b and 53c further extended to reach the release section 3f of the locking pawl 3, such that when the thumb press section 53a is pressed down to actuate the disengagement of the second ratchet system, the locking pawl 3 is also disengaged from the ratchet trigger 4 to allow the ratchet trigger 4 reset to an initial position.

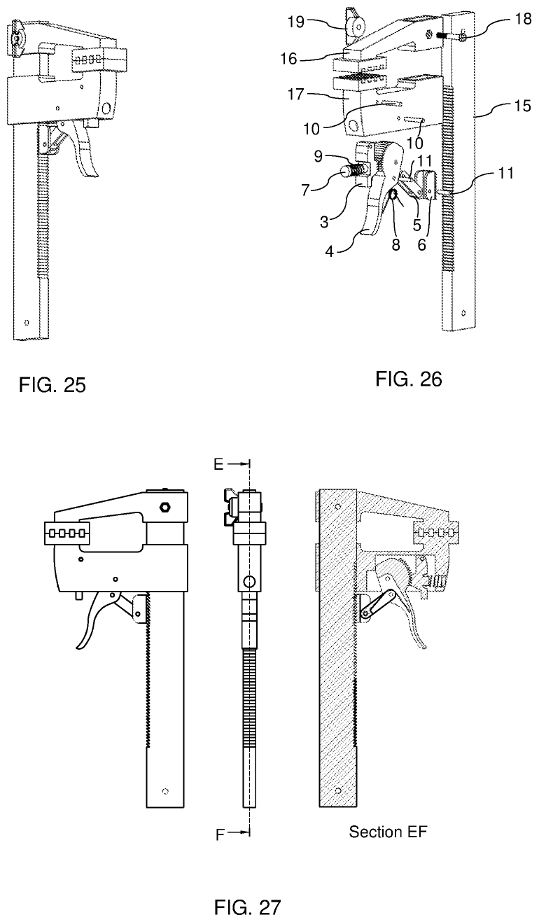

FIG. 25 to FIG. 30 illustrate a single rail clamping apparatus in a preferred embodiment as a wood clamp. In accordance to this embodiment the “J” shape frame 1 of FIG. 2 may be replaced by a mountable fixed jaw 16 and a frame 15, the movable jaw 2 of FIG. 2 may be replaced by a movable jaw 17, a fastening means consisting of a bolt 18 and a wingnut 19 may be employed to secure the fixed jaw 16 to the frame 15, and the other components may remain the same as the plumbing wrench of FIG. 2.

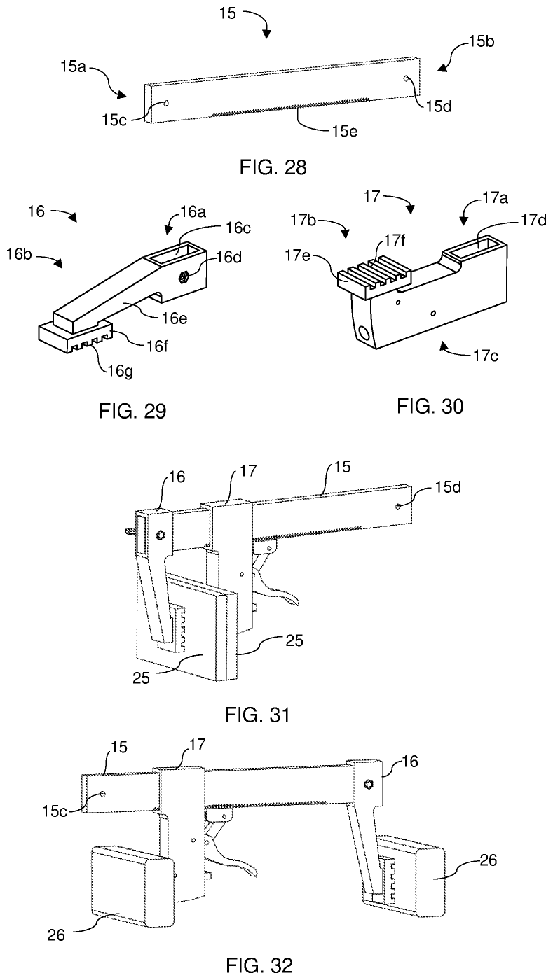

The frame 15 (FIG. 28) having a longitudinal body may comprise a clamping end 15a having a first bore hole 15c, a spacing end 15b having a second bore hole 15d, and a longitudinal ratchet rack 15e disposed in the middle on a longitudinal edge of the body and is integral to the longitudinal edge. The fixed jaw 16 (FIG. 29) having an elongated body may comprise a tube section 16a having a slotted cutout 16c sized and shaped to circumscribe and receive the frame 15 and a bore hole 16d through both lateral walls to receive the bolt 18 on one end, and a fixed jaw section 16b consisting of an overhanging arm 16e in the middle and a clamping head 16f having a frontal gripping face 16g on the other end. The movable jaw 17 (FIG. 30) having an elongated body may comprise a tube section 17a having a slotted cutout 17d sized and shaped to circumscribe and slidably receive the frame 15 on one end, a ratchet housing section 17c in the middle, and a movable jaw section 17b consisting of a clamping head 17e having a frontal gripping face 17f sized and shaped to pair up with and oppose to the clamping head 16f to form a pair of jaws on the other end. The ratchet housing section 17c may have identical structure as the housing section 2c of the movable jaw 2 (FIG. 4) to house other identical components. The first and second ratchet systems are configured to have identical configurations of the plumbing wrench of FIG. 2 when the fixed jaw 16 is mounted on the clamping end 15a.

When the fixed jaw 16 is mounted on the clamping end 15a having the griping face 16g facing inward lengthwise to the frame 15 and secured to the clamping end 15a via the aligned bore holes 15c and 16d, the bolt 18 and the wingnut 19, the clamping head 16f pairs up with and faces towards the clamping head 17e, forming a pair of clamping jaws and a clamping configuration. Whereas when the fixed jaw 16 is mounted on the spacing end 15b having the clamping head 16f facing outward lengthwise to the frame 15 and secured to the spacing end 15b, the clamping head 16f pairs up with and faces away from the clamping head 17e to form a pair of spacing jaws and a spacing configuration.

FIG. 31 and FIG. 32 further illustrate how the wood clamp of FIG. 25 may be used. FIG. 31 shows when the fixed jaw 16 is mounted on the frame 15 in the clamping configuration, the wood clamp may be used to clamp and fix a pair of wood boards 25 in a fixed relative position. FIG. 32 shows when the mountable fixed jaw 16 is mounted on the frame 15 in the spacing configuration, the wood clamp may be used to support and space a pair of lumbers 26 in a fixed relative position when the outward movements of the pair of lumbers 26 are limited.

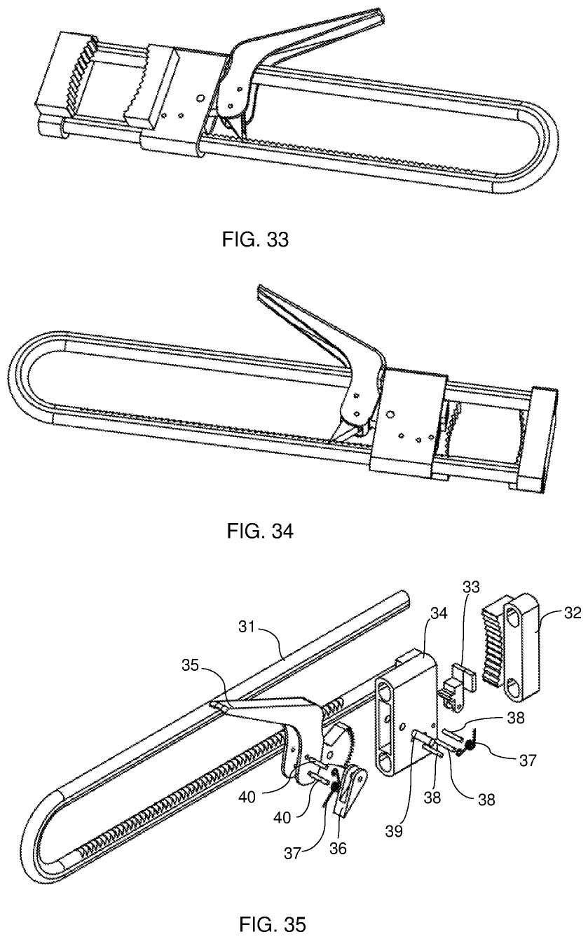

FIG. 33 and FIG. 34 show a dual rail clamping apparatus in a preferred embodiment as a jar opener.

FIG. 35 to FIG. 42 further show how the jar opener is constructed. The jar opener may comprise a frame 31, a fixed jaw 32, a locking pawl 33, a movable jaw 34, a ratchet trigger 35, a driving pawl linkage 36, a plurality of springs 37 having a ring end 37a and a straight end 37b (FIG. 42), a plurality of pins 38, 39 and 40.

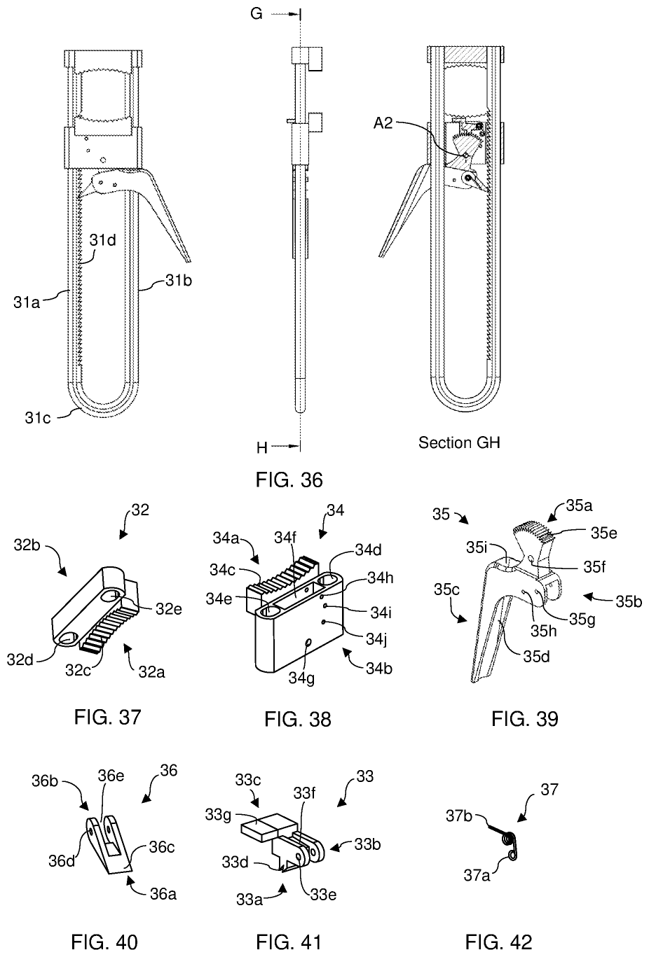

The frame 31 (FIG. 36) having a “U” shape longitudinal body may comprise a first longitudinal rail 31a and a second longitudinal rail 31b significantly parallel to each other and bridged by a transverse bridging section 31c on one end, thereby leaving an open end on the other end. The first rail 31a may further comprise a longitudinal ratchet rack 31d disposed on the inward-facing longitudinal edge, and is integral to the longitudinal edge. The second rail 31b may have smooth surfaces for guiding and supporting the movable jaw 34. The frame 31 functions as a dual rail for the movable jaw 34, a ratchet rack, as well as a handle.

The fixed jaw 32 (FIG. 35, FIG. 36, FIG. 37) may comprise an elongated fixed jaw section 32a and an elongated support section 32b disposed side by side; the fixed jaw section 32a may further comprise a curved toothed griping face 32c; the support section 32b may further comprise a pair of tube sections 32d and 32e spaced, sized and shaped to receive the first and second rails 31a and 31b disposed distally on both ends; the fixed jaw 32 receives and is affixed to the frame 31 at the open end having the griping face 32c face inwards to support the frame 31.

The movable jaw 34 (FIG. 35, FIG. 36 FIG. 38) may comprise an elongated movable jaw section 34a and an elongated support section 34b disposed side by side; the movable jaw section 34a may further comprise a curved toothed gripping face 34c to pair up with and oppose to the griping face 32c to form a pair of jaws; the support section 34b may further comprise a pair of tube sections 34d and 34e spaced, sized and shaped to slidably receive the first and second rails 31a and 31b disposed distally on both ends, connected by a ratchet housing section 34f consisting of a slotted cutout generally parallel to the pair of tube sections 34d and 34e in the middle; the ratchet housing section 34f may further comprise a first pair of hinge seats 34g disposed centrally along the bottom edge through both lateral walls to pivotally connect with the ratchet trigger 35 via a pin 39 and form a first pivot, a second pair of hinge seats 34h disposed along the top edge through both lateral walls positioned accordingly to pivotally connect with the locking pawl 33 and an elastic member 37 via a first pin 38, a first bore hole 34i through both lateral walls disposed accordingly to coaxially connect with the ring end 37a of the elastic member 37 via a second pin 38 to fix the ring end of the elastic member 37, and a second bore hole 34j through both lateral walls disposed accordingly to stationarily receive a third pin 38 to form a rotation limit and an initial position for the ratchet trigger 35.

The ratchet trigger 35 (FIG. 35, FIG. 36, FIG. 39) having a curvy longitudinal body may comprise a frontal ratchet head 35a on one end, a pivot section 35b in the middle, a trigger arm section 35c on the other end and a “L” shape notched slot 35d running across the underbody of the trigger arm section 35c and extending through the pivot section 35b; the ratchet head 35a having a fan disc shape body may further comprise a frontal arc ratchet face 35e coaxial to an axial center bore 35f centered on the axis A2, and is sized to be rotatably received into the ratchet housing section 34f; the pivot section 35b may further comprise a pair of hinge seats 35g positioned and sized accordingly to pivotally connect with the driving pawl linkage 36 and another elastic member 37 via a pin 40 to form a second pivot on one end, and a bore hole 35h through both walls of the notched slot 35d in the middle positioned and sized accordingly to coaxially connect with the ring end 37a of the other elastic member 37 via another pin 40; the trigger arm section 35c may comprise an opening 35i at the corner of where the trigger arm section 35c meets the pivot section 35b sized and shaped to slidably receive the second rail 31b and also allow the trigger arm section 35c to swing away or closer to the second rail 31b about the axis A2.

The locking pawl 33 (FIG. 41) may comprise a release section 33c on one end, a pawl head section 33a and a support section 33b back-to-back oriented on the other end; the pawl head section 33a is sized to be rotatably received into the ratchet housing section 34f and may comprise an integral pawl face 33d sized and shaped to engage with the ratchet face 35e to form a first ratchet system; the support section 33b may further comprise a pair of hinge seats 33e at the end of a notched slot 33f to pivotally connected with the pair of hinge seats 34h of the movable jaw 34 and the elastic member 37 via the first pin 38, and support the straight end 37b of the elastic member 37 in the notched slot 33f, thereby providing a first elastic force between the movable jaw 34 and the locking pawl 33; the release section 33c may consist of a flat tab 33g sized and shaped to cover the top side and overhangs to one side of the ratchet housing section 34f to expose part of the flat tab 33g when assembled, such that a user may flip up the release section 33c to disengage the first ratchet system.

The driving pawl linkage 36 having a longitudinal body may comprise a pawl head end 36a having an integral pawl tooth 36c sized and shaped to engage with the ratchet rack 31d to form a second ratchet system, and a pivoting end 36b consisting of a pair of hinge seats 36d on both walls of a notched slot 36e to pivotally connect with the pair of hinge seats 35g and the other elastic member 37 via another pin 40 to form the second pivot; whereas the notched slot 36e supports the straight end 37b of the other elastic member 37, providing a second elastic force to urge the trigger arm section 35c to rotate outwards away from the second rail 31b and a third elastic force to urge the engagement of the driving pawl linkage 36 and the ratchet rack 31d. The driving pawl linkage 36 functions as a cascading mechanism between the first and second ratchet systems to translate the rotation of the ratchet trigger 35 into the linear movement of the movable jaw 34 relative to the fixed jaw 32 when the second ratchet system is engaged.

The first ratchet system is configured in such a way that when the trigger arm section 35c is rotated closer to the second rail 31b from the initial position, the ratchet face 35e pushes away the pawl face 33d to disengage the first ratchet system and allow the trigger arm section 35c to continue to be rotated forward closer to the second rail 31b until stopped by the frame 31, forming a final position; and when the trigger arm section 35c stops being rotated forward, the first elastic force urges the engagement of the first ratchet system and locks the ratchet trigger 35 in a fixed position, preventing the ratchet arm section 35c from being rotated outwards away from the second rail 31b by the second elastic force, thereby forming a directional self-locking mechanism. When an overcoming force is applied to the release section 33c to counter the first elastic force, the pawl face 33d is rotated apart from the ratchet face 35e to disengage the first ratchet system, and the second elastic force urges the ratchet arm section 35c to rotate away from the second rail 31b until reaching the initial position, thereby resetting the ratchet trigger 35.

The second ratchet system is configured in such a way that when the movable jaw 34 is slid forward closer to the fix jaw 32, the ratchet rack 31d pushes away the pawl tooth 36c to disengage the second ratchet system and allow the movable jaw 34 to continue to be slid forward until stopped by a workpiece or the fixed jaw 32; and when the movable jaw 34 stops being slid forward, the third elastic force urges the engagement of the second ratchet system, thereby preventing the movable jaw 34 from being slid backward and forming another directional self-locking mechanism.

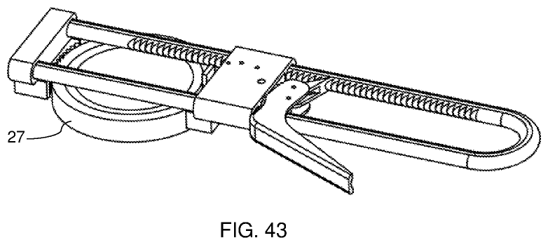

FIG. 43 further shows how the jar opener can be used to operate on a jar lid 27.

A user may use the release section 33c of the locking pawl 33 to disengage the first ratchet system and allow the second elastic force to reset the ratchet trigger 35 to the initial position. The user may then rotate the driving pawl linkage 36 away from the ratchet rack 31d to disengage the second ratchet system and slide down the movable jaw 34 to create sufficient gap between the pair of jaws. The user may then place the jar lid 27 between the fixed jaw 32 and the movable jaw 34, and slide the movable jaw 34 forward until stopped by the jar lid 27 such that the driving pawl linkage 36 is engaged in a highest possible fixed position while there may still be slack between the jar lid 27 and the pair of jaws. The user may then actuate the cascading mechanism by pulling the trigger arm section 35c forward to the second rail 31b to incrementally reduce the gap between the pair of jaws until the jar lid 27 is firmly in contact with the pair of jaws. From this point on any further gap reduction effort translates into an increasing clamping force on the jar lid 27. When the trigger arm section 35c is released, the locking pawl 33 self-locks the ratchet trigger 35 in a fixed position, such that the majority of the clamping force is retained via elastic deformation of all components involved. The user then may then turn the jar lid 27 by the frame 31, without having to keep constant pressure on the trigger arm section 35c.

I claim:

1. A single rail self-locking and adjustable dual ratchet clamping apparatus comprising:
a frame having a body comprising a longitudinal rail section connected by at least a fixed jaw section protruding transversely from one end of said rail section, thereof said rail section further comprises a ratchet rack disposed on a longitudinal edge of said rail section and is integral to said longitudinal edge; thereof said at least a fixed jaw section further comprises at least an inward facing griping face;
a movable jaw having an elongated body, wherein said movable jaw comprises a least a movable jaw section, a ratchet housing section and a tube section; thereof said a least a movable jaw section further comprises a least a griping face; thereof said tube section is sized and shaped to circumscribe and slidably receive said rail section of said frame; thereof said ratchet housing section comprises a recess having a pivoting means adjacent to said tube section, and is back-to-back oriented to said at least a movable jaw section;
an integrated ratchet trigger having a curvy longitudinal body, wherein said ratchet trigger comprises a transversely protruding ratchet head section having an integral arc ratchet face and a first pivoting means on one end, a pivot section having a second pivoting means, and a trigger arm section on the other end; thereof said arc ratchet face is coaxial to the axis of said first pivoting means; thereof the axis of said second pivoting means is significantly parallel to the axis of said first pivoting means; thereof said ratchet head section is sized and shaped to be rotatably received into said ratchet housing section of said movable jaw;
a locking pawl comprising a pawl head section, a support section and a release section, thereof said pawl head section is sized and shaped to be movably received into said ratchet housing section of said movable jaw; thereof said pawl head section further comprises an integral pawl face sized and shaped to engage with said arc ratchet face of said ratchet trigger;
a cascading driving pawl system comprising a driving pawl to engage with said ratchet rack of said frame and a cascading linkage system having at least a pivoting means to connect said ratchet trigger and said driving pawl;
at least an elastic member;
wherein said rail section of said frame is slidably received into said tube section of said movable jaw having said at least a griping face of said at least a movable jaw section pair up with and oppose to said at least a griping face of said at least a fixed jaw section to form at least a pair of jaws to clamp on a workpiece, thereby said movable jaw is slidably carried by said frame and is slidable along said rail section relative to said at least a fixed jaw section;
wherein said ratchet trigger is rotatably received into said ratchet housing section of said movable jaw via pivotally connecting said first pivoting means of said ratchet head section with said pivoting means of said ratchet housing section and forming a first pivot; thereof said ratchet trigger is rotatable within a limited range defined by an initial position and a final position; whereas after being assembled said trigger arm section is exposed outside of said ratchet housing section alongside said rail section of said frame, such that a user may use finger(s) to operate said trigger arm section to rotate said ratchet trigger within said limited range;
wherein said pawl head section of said locking pawl is movably received into and supported by said ratchet housing section of said movable jaw, having said pawl face engaged with said arc ratchet face of said ratchet trigger to form a first ratchet system;
wherein said at least an elastic member provides a first elastic force between said movable jaw and said support section of said locking pawl to urge the engagement of said first ratchet system;
wherein said at least an elastic member further provides a second elastic force between said ratchet trigger and said frame to urge said trigger arm section of said ratchet trigger to rotate away from said rail section of said frame;
wherein said first ratchet system is configured in such a way that when an overcoming force is applied to said trigger arm section to counter said second elastic force and rotate said trigger arm section in a direction closer to said frame, said force also counters said first elastic force by driving said arc ratchet face to rotate about said first pivot and push away said pawl face of said locking pawl to disengage said first ratchet system, thereby allowing said ratchet trigger to continue to rotate in said direction until reaching said final position; whereas when said force is removed, said first elastic force urges the engagement of said first ratchet system, self-locking said ratchet trigger in a fixed position and preventing said ratchet trigger from being driven by said second elastic force to rotate in counter said direction, thereby forming a directional self-locking mechanism;
wherein when an overcoming force is applied to said release section of said locking pawl to counter said first elastic force and move said locking pawl apart from said ratchet trigger, said first ratchet system disengages and said second elastic force urges said trigger arm section to rotate away from said frame until reaching said initial position, thereby resetting said first ratchet system;
wherein said at least an elastic member further provides a third elastic force between said driving pawl of said cascading driving pawl system and said frame to urge said driving pawl to engage with said ratchet rack of said frame, thereby forming a second ratchet system;
Wherein said cascading driving pawl system is pivotally connected to said second pivoting means of said ratchet trigger via said at least a pivoting means to form a second pivot and a cascading mechanism between said first and second ratchet systems, such that the rotation of said second pivot about said first pivot drives the linear movement of said driving pawl along said rail section of said frame, and when said trigger arm section of said ratchet trigger is rotated closer to said rail section of said frame, said driving pawl is driven to move apart from said movable jaw;
Wherein said second ratchet system is configured in such a way that when said movable jaw is slid forward closer to said at least a fix jaw section of said frame, said ratchet rack pushes away said driving pawl to disengage said second ratchet system, thereby allowing said movable jaw to continue to be slid forward until stopped by a work piece or said at least a fixed jaw section; whereas when said movable jaw stops being slid forward, said third elastic force urges the engagement of said second ratchet system, self-locking said driving pawl in a fixed position and preventing said movable jaw from being slid backward, thereby forming another directional self-locking mechanism;
wherein when said second ratchet system is engaged, and a subsequent force is applied to drive said trigger arm section to rotate closer to said rail section of said frame, the rotation of said ratchet trigger is translated into the linear movement of said movable jaw forward closer to said at least a fixed jaw section, thereby the gap(s) between said at least a pair of jaws is(are) reduced incrementally; wherein when the gap reduction of said at least a pair of jaws is stopped by a workpiece placed in-between, further gap reduction effort from said subsequent force translates into an increasing clamping force on said workpiece; whereas when said subsequent force is removed said locking pawl self-locks said ratchet trigger in a fixed position, thereby the majority of said clamping force is retained via the elastic deformation of all components involved; and
wherein when an overcoming force is applied to counter said third elastic force and disengage said second ratchet system, said movable jaw is slidable relative to said at least a fixed jaw section of said frame to increase or reduce the gap(s) between said at least a pair of jaws.

2. The single rail self-locking and adjustable dual ratchet clamping apparatus of claim 1, wherein said cascading linkage system of said cascading driving pawl system consists of an individual linkage, thereof said individual linkage further comprises a longitudinal body having a first pivoting end and a second pivoting end, thereof said at least a pivoting means of said cascading linkage system further comprises a first pivoting means disposed on said first pivoting end and a second pivoting means disposed on said second pivoting end; wherein said driving pawl of said cascading driving pawl system consists of an individual driving pawl, thereof said individual driving pawl further comprises a pivoting means and a pawl head having a plurality of pawl teeth, thereof said pawl head is sized and shaped to engage with said ratchet rack of said frame to form said second ratchet system; and wherein said individual linkage is pivotally connected to said second pivoting means of said ratchet trigger via said first pivoting means on said first pivoting end to form said second pivot, and is pivotally connected to said pivoting means of said individual driving pawl via said second pivoting means on said second pivoting end having said plurality of pawl teeth engaged with said ratchet rack of said frame.

3. The single rail self-locking and adjustable dual ratchet clamping apparatus of claim 1, wherein said cascading linkage system and said driving pawl of said cascading driving pawl system are integrated into an individual driving pawl linkage, thereof said individual driving pawl linkage further comprises a longitudinal body having a pivoting end and an integral pawl head end consisting of an integral pawl tooth sized and shaped to engage with said ratchet rack of said frame to form said second ratchet system; thereof said at least a pivoting means of said cascading linkage system further comprises a first pivoting means disposed on said pivoting end; and wherein said individual driving pawl linkage is pivotally connected to said second pivoting means of said ratchet trigger via said first pivoting means on said pivoting end to form said second pivot having said integral pawl tooth engaged with said ratchet rack of said frame.

4. A single rail self-locking and adjustable dual ratchet clamping apparatus comprising:
a frame having a longitudinal body comprising a clamping end and a spacing end, thereof said frame further comprises a ratchet rack disposed on a longitudinal edge of said frame and is integral to said longitudinal edge;
a fixed jaw having an elongated body, wherein said fixed jaw comprises at least a fixed jaw section connected by a tube section, thereof said at least a fixed jaw section further comprises at least a griping face; thereof said tube section is sized and shaped to circumscribe said frame;
a movable jaw having an elongated body, wherein said movable jaw comprises a least a movable jaw section, a ratchet housing section and a tube section; thereof said a least a movable jaw section further comprises a least a griping face; thereof said tube section is sized and shaped to circumscribe and slidably receive said frame; thereof said ratchet housing section comprises a recess having a pivoting means adjacent to said tube section, and is back-to-back oriented to said at least a movable jaw section;
an integrated ratchet trigger having a curvy longitudinal body, wherein said ratchet trigger comprises a transversely protruding ratchet head section having an integral arc ratchet face and a first pivoting means on one end, a pivot section having a second pivoting means, and a trigger arm section on the other end; thereof said arc ratchet face is coaxial to the axis of said first pivoting means; thereof the axis of said second pivoting means is significantly parallel to the axis of said first pivoting means; thereof said ratchet head section is sized and shaped to be rotatably received into said ratchet housing section of said movable jaw;
a locking pawl comprising a pawl head section, a support section and a release section, thereof said pawl head section is sized and shaped to be movably received into said ratchet housing section of said movable jaw; thereof said pawl head section further comprises an integral pawl face sized and shaped to engage with said arc ratchet face of said ratchet trigger;
a cascading driving pawl system comprising a driving pawl to engage with said ratchet rack of said frame and a cascading linkage system having at least a pivoting means to connect said ratchet trigger and said driving pawl;
at least an elastic member;
wherein a clamping configuration is formed when said fixed jaw is mounted on and secured to said clamping end of said frame via said tube section having said at least a griping face facing inwards lengthwise to said frame;
wherein a spacing configuration is formed when said fixed jaw is mounted on and secured to said spacing end of said frame via said tube section having said at least a griping face facing outwards lengthwise to said frame;
wherein said frame is slidably received into said tube section of said movable jaw having said at least a griping face of said at least a movable jaw section pair up with and oppose to said at least a griping face of said at least a fixed jaw section in said clamping configuration to form at least a pair of jaws to clamp on a plurality of workpieces; thereby said movable jaw is slidably carried by said frame and is slidable along said frame;
wherein said ratchet trigger is rotatably received into said ratchet housing section of said movable jaw via pivotally connecting said first pivoting means of said ratchet head section with said pivoting means of said ratchet housing section and forming a first pivot; thereof said ratchet trigger is rotatable within a limited range defined by an initial position and a final position; whereas after being assembled said trigger arm section is exposed outside of said ratchet housing section alongside said frame, such that a user may use finger(s) to operate said trigger arm section to rotate said ratchet trigger within said limited range;
wherein said pawl head section of said locking pawl is movably received into and supported by said ratchet housing section of said movable jaw, having said pawl face engaged with said arc ratchet face of said ratchet trigger to form a first ratchet system;
wherein said at least an elastic member provides a first elastic force between said movable jaw and said support section of said locking pawl to urge the engagement of said first ratchet system;
wherein said at least an elastic member further provides a second elastic force between said ratchet trigger and said frame to urge said trigger arm section of said ratchet trigger to rotate away from said frame;
wherein said first ratchet system is configured in such a way that when an overcoming force is applied to said trigger arm section to counter said second elastic force and rotate said trigger arm section in a direction closer to said frame, said force also counters said first elastic force by driving said arc ratchet face to rotate about said first pivot and push away said pawl face of said locking pawl to disengage said first ratchet system, thereby allowing said ratchet trigger to continue to rotate in said direction until reaching said final position; whereas when said force is removed, said first elastic force urges the engagement of said first ratchet system, self-locking said ratchet trigger in a fixed position and preventing said ratchet trigger from being driven by said second elastic force to rotate in counter said direction, thereby forming a directional self-locking mechanism;
wherein when an overcoming force is applied to said release section of said locking pawl to counter said first elastic force and move said locking pawl apart from said ratchet trigger, said first ratchet system disengages and said second elastic force urges said trigger arm section to rotate away from said frame until reaching said initial position, thereby resetting said first ratchet system;
wherein said at least an elastic member further provides a third elastic force between said driving pawl of said cascading driving pawl system and said frame to urge said driving pawl to engage with said ratchet rack of said frame, thereby forming a second ratchet system;
Wherein said cascading driving pawl system is pivotally connected to said second pivoting means of said ratchet trigger via said at least a pivoting means to form a second pivot and a cascading mechanism between said first and second ratchet systems, such that the rotation of said second pivot about said first pivot drives the linear movement of said driving pawl along said frame, and when said trigger arm section of said ratchet trigger is rotated closer to said frame, said driving pawl is driven to move apart from said movable jaw;
Wherein said second ratchet system is configured in such a way that when said movable jaw is slid forward closer to said clamping end of said frame, said ratchet rack pushes away said driving pawl to disengage said second ratchet system, thereby allowing said movable jaw to continue to be slid forward until stopped by a work piece or said fixed jaw in said clamping configuration; whereas when said movable jaw stops being slid forward, said third elastic force urges the engagement of said second ratchet system, self-locking said driving pawl in a fixed position and preventing said movable jaw from being slid backward; thereby forming another directional self-locking mechanism
wherein when said second ratchet system is engaged, and a subsequent force is applied to drive said trigger arm section to rotate closer to said frame, the rotation of said ratchet trigger is translated into the linear movement of said movable jaw forward closer to said clamping end of said frame; wherein when said fixed jaw is in said clamping configuration the gap(s) between said at least a pair of jaws is(are) reduced incrementally, thereof when the gap reduction of said at least a pair of jaws is stopped by a plurality of workpieces placed in-between, further gap reduction effort from said subsequent force is translated into an increasing clamping force on said plurality of workpieces to clamp said plurality of workpieces in a fixed relative position; whereas when said fixed jaw is in said spacing configuration the space between said at least a pair of jaws is increased incrementally, thereof when the space increase of said at least a pair of jaws placed in-between said plurality of workpieces is stopped by said plurality of workpieces, further space increase effort from said subsequent force translates into an increasing spacing force on said plurality of workpieces to support and space apart said plurality of workpieces in a fixed relative position; whereas when said subsequent force is removed said locking pawl self-locks said ratchet trigger in a fixed position, thereby the majority of said clamping force or said spacing force is retained via the elastic deformation of all components involved; and
wherein when an overcoming force is applied to counter said third elastic force and disengage said second ratchet system, said movable jaw is slidable between said clamping end and said spacing end of said frame.

5. The single rail self-locking and adjustable dual ratchet clamping apparatus of claim 4, wherein said cascading linkage system of said cascading driving pawl system consists of an individual linkage, thereof said individual linkage further comprises a longitudinal body having a first pivoting end and a second pivoting end, thereof said at least a pivoting means of said cascading linkage system further comprises a first pivoting means disposed on said first pivoting end and a second pivoting means disposed on said second pivoting end; wherein said driving pawl of said cascading driving pawl system consists of an individual driving pawl, thereof said individual driving pawl further comprises a pivoting means and a pawl head having a plurality of pawl teeth, thereof said pawl head is sized and shaped to engage with said ratchet rack of said frame to form the second ratchet system; and wherein said individual linkage is pivotally connected to said second pivoting means of said ratchet trigger via said first pivoting means on said first pivoting end to form said second pivot, and is pivotally connected to said pivoting means of said individual driving pawl via said second pivoting means on said second pivoting end having said plurality of pawl teeth engaged with said ratchet rack of said frame.

6. The single rail self-locking and adjustable dual ratchet clamping apparatus of claim 4, wherein said cascading linkage system and said driving pawl of said cascading driving pawl system are integrated into an individual driving pawl linkage, thereof said individual driving pawl linkage further comprises a longitudinal body having a pivoting end and an integral pawl head end consisting of an integral pawl tooth sized and shaped to engage with said ratchet rack of said frame to form said second ratchet system; thereof said at least a pivoting means of said cascading linkage system further comprises a first pivoting means disposed on said pivoting end; and wherein said individual driving pawl linkage is pivotally connected to said second pivoting means of said ratchet trigger via said first pivoting means on said pivoting end to form said second pivot having said integral pawl tooth engaged with said ratchet rack of said frame.

7. A dual rail self-locking and adjustable dual ratchet clamping apparatus comprising:
a frame having a U shape longitudinal body comprising a first rail, a second rail and a bridging section, thereof said first rail is significantly parallel to said second rail lengthwise and in conjunction with said second rail form a dual rail system; thereof said bridging section bridges said first and second rails on one end, leaving an opening between a pair of open ends on the other end; thereof said first rail further comprises a ratchet rack disposed on an inward longitudinal edge of said first rail facing said second rail, and is integral to said longitudinal edge;
a fixed jaw comprising an elongated fixed jaw section having a griping face and an elongated support section side-by-side oriented; thereof said support section further comprises a pair of significantly parallel tube sections on both ends; thereof said pair of tube sections are sized, spaced and shaped to circumscribe and receive said pair of open ends of said frame;
a movable jaw comprising an elongated movable jaw section having a griping face and an elongated support section side-by-side oriented, thereof said support section further comprises a pair of significantly parallel tube sections on both ends connected by a ratchet housing section in the middle; thereof said pair of tube sections are sized, spaced and shaped to circumscribe and slidably receive said first and second rails of said frame; thereof said ratchet housing section comprises a slotted cutout oriented lengthwise to said frame between said pair of tube sections when assembled and a pivoting means;
an integrated ratchet trigger having a curvy longitudinal body, wherein said ratchet trigger comprises a ratchet head section having an integral arc ratchet face and a first pivoting means on one end, a pivot section having a second pivoting means in the middle, and a trigger arm section having an opening generally along the longitudinal direction and adjacent to said pivot section on the other end; thereof said arc ratchet face is coaxial to the axis of said first pivoting means; thereof the axis of said second pivoting means is significantly parallel to the axis of said first pivoting means; thereof said ratchet head section is sized and shaped to be rotatably received into said ratchet housing section of said movable jaw; thereof said opening of said trigger arm section is sized to receive said second rail of said frame and have room to allow said trigger arm section to swing laterally closer to or away from said second rail;
a locking pawl comprising a pawl head section, a support section and a release section, thereof said pawl head section is sized and shaped to be movably received into said ratchet housing section of said movable jaw; thereof said pawl head section further comprises an integral pawl face sized and shaped to engage with said arc ratchet face of said ratchet trigger;
a cascading driving pawl system comprising a driving pawl to engage with said ratchet rack of said frame and a cascading linkage system having at least a pivoting means to connect said ratchet trigger and said driving pawl;
at least an elastic member;
wherein said fixed jaw receives and is affixed to said pair of open ends of said frame via said pair of tube sections having said griping face facing inwards lengthwise to said frame;
wherein said first and second rails of said frame are slidably received into said pair of tube sections of said movable jaw having said griping face of said movable jaw pair up with and oppose to said griping face of said fixed jaw to form a pair of jaws to clamp on a workpiece, thereby said movable jaw is slidably carried by said frame and is slidable along said dual rail system;
wherein said ratchet trigger is rotatably received into said ratchet housing section of said movable jaw via pivotally connecting said first pivoting means of said ratchet head section with said pivoting means of said ratchet housing section and forming a first pivot; thereof said ratchet trigger is rotatable within a limited range defined by an initial position and a final position; whereas after being assembled said trigger arm section is exposed outside of said ratchet housing section, and is disposed outwards alongside said second rail of said frame having said second rail going through said opening of said trigger arm section, such that a user may use finger(s) to operate said trigger arm section to rotate said ratchet trigger within said limited range;
wherein said locking pawl is movably received into and supported by said ratchet housing section of said movable jaw, having said pawl face engaged with said arc ratchet face of said ratchet trigger to form a first ratchet system;
wherein said at least an elastic member provides a first elastic force between said movable jaw and said support section of said locking pawl to urge the engagement of said first ratchet system;
wherein said at least an elastic member further provides a second elastic force between said ratchet trigger and said frame to urge said trigger arm section of said ratchet trigger to rotate outwards away from said second rail of said frame;
wherein said first ratchet system is configured in such a way that when an overcoming force is applied to said trigger arm section to counter said second elastic force and rotate said trigger arm section in a direction closer to said frame, said force also counters said first elastic force by driving said arc ratchet face to rotate about the axis of said first pivot and push away said pawl face of said locking pawl to disengage said first ratchet system, thereby allowing said ratchet trigger to continue to rotate in said direction until reaching said final position; whereas when said force is removed, said first elastic force urges the engagement of said first ratchet system, self-locking said ratchet trigger in a fixed position and preventing said ratchet trigger from being driven by said second elastic force to rotate in counter said direction, thereby forming a directional self-locking mechanism;
wherein when an overcoming force is applied to said release section of said locking pawl to counter said first elastic force and move said locking pawl apart from said ratchet trigger, said first ratchet system disengages and said second elastic force urges said trigger arm section to rotate outwards away from said frame until reaching said initial position, thereby resetting said first ratchet system;
wherein said at least an elastic member further provides a third elastic force between said driving pawl of said cascading driving pawl system and said frame to urge said driving pawl to engage with said ratchet rack of said frame, thereby forming a second ratchet system;
Wherein said cascading driving pawl system is pivotally connected to said second pivoting means of said ratchet trigger via said at least a pivoting means to form a second pivot and a cascading mechanism between said first and second ratchet systems, such that the rotation of said second pivot about said first pivot drives the linear movement of said driving pawl along said dual rail system, and when said trigger arm section of said ratchet trigger is rotated closer to said second rail of said frame, said driving pawl is driven to move apart from said movable jaw;
Wherein said second ratchet system is configured in such a way that when said movable jaw is slid forward closer to said fixed jaw, said ratchet rack pushes away said driving pawl to disengage said second ratchet system, thereby allowing said movable jaw to continue to be slid forward until stopped by a work piece or said fixed jaw; whereas when said movable jaw stops being slid forward, said third elastic force urges the engagement of said second ratchet system, self-locking said driving pawl in a fixed position and preventing said movable jaw from being slid backward, thereby forming another directional self-locking mechanism;
wherein when said second ratchet system is engaged, and a subsequent force is applied to drive said trigger arm section to rotate closer to said second rail of said frame, the rotation of said ratchet trigger is translated into the linear movement of said movable jaw forward closer to said fixed jaw, thereby the gap between said pair of jaws is reduced incrementally; wherein when the gap reduction of said pair of jaws is stopped by a workpiece placed in-between, further gap reduction effort from said subsequent force translates into an increasing clamping force on said workpiece; whereas when said subsequent force is removed said locking pawl self-locks said ratchet trigger in a fixed position, thereby the majority of said clamping force is retained via the elastic deformation of all components involved; and
wherein when an overcoming force is applied to counter said third elastic force and disengage said second ratchet system, said movable jaw is slidable relative to said fixed jaw to increase or reduce the gap between said pair of jaws.

8. The dual rail self-locking and adjustable dual ratchet clamping apparatus of claim 7, wherein said cascading linkage system of said cascading driving pawl system consists of an individual linkage, thereof said individual linkage further comprises a longitudinal body having a first pivoting end and a second pivoting end, thereof said at least a pivoting means of said cascading linkage system further comprises a first pivoting means disposed on said first pivoting end and a second pivoting means disposed on said second pivoting end; wherein said driving pawl of said cascading driving pawl system consists of an individual driving pawl, thereof said individual driving pawl further comprises a pivoting means and a pawl head having a plurality of pawl teeth, thereof said pawl head is sized and shaped to engage with said ratchet rack of said frame to form said second ratchet system; and wherein said individual linkage is pivotally connected to said second pivoting means of said ratchet trigger via said first pivoting means on said first pivoting end to form said second pivot, and is pivotally connected to said pivoting means of said individual driving pawl via said second pivoting means on said second pivoting end having said plurality of pawl teeth engaged with said ratchet rack of said frame.

9. The dual rail self-locking and adjustable dual ratchet clamping apparatus of claim 7, wherein said cascading linkage system and said driving pawl of said cascading driving pawl system are integrated into an individual driving pawl linkage, thereof said individual driving pawl linkage further comprises a longitudinal body having a pivoting end and an integral pawl head end consisting of an integral pawl tooth sized and shaped to engage with said ratchet rack of said frame to form said second ratchet system; thereof said at least a pivoting means of said cascading linkage system further comprises a first pivoting means disposed on said pivoting end; and wherein said individual driving pawl linkage is pivotally connected to said second pivoting means of said ratchet trigger via said first pivoting means on said pivoting end to form said second pivot having said integral pawl tooth engaged with said ratchet rack of said frame.
